(19) United States
(12) Patent Application Publication
(10) Pub. No.: US 2002/0099774 A1
(43) Pub. Date: Jul. 25, 2002

(54) Information reproducing method and information reproducing system

(75) Inventors: Jun-Ichi Yamato, Tokyo (JP); Akihisa Kenmochi, Tokyo (JP); Hiroshi Matoba, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/023,083

(22) Filed: Dec. 17, 2001

(30) Foreign Application Priority Data
Jan. 22, 2001 (JP) 2001-013585

(51) Int. Cl. G06F 15/16

(52) U.S. Cl. 709/204

(57) ABSTRACT

A plurality of terminal devices each for displaying information on its screen are interconnected for making communications with one another through a network. A terminal device that creates schedule data for displaying information on the screens of all the terminal devices at an arbitrary time delivers the schedule data to the other terminal devices through the network. Terminal devices that receive the schedule data reproduce the information associated with the schedule data from information previously recorded therein to display the same information on a plurality of screens in synchronization.

### BACKGROUND OF THE INVENTION

1. Field of the Invention

The present invention relates to an information reproducing method and system for displaying the same information on a plurality of screens at remote locations in synchronization with one another.

2. Description of the Related Art

As a means for sharing the same information such as a moving image, speech and the like among people who live in remote regions (hereinafter called the “users”), television broadcasting, radio broadcasting, and the like have been used in practice. There is also a method of sharing information by recording image data on recording media such as a magnetic tape, an optical disc or the like and distributing the recording media to respective users.

Further, as a result of the recent development of communication networks and information processing apparatuses, image data and the like are delivered via networks such as the Internet to allow the users to share the same information.

Since information processing apparatuses such as a computer, a portable telephone and the like can be utilized as communication means between users through electronic mail, chat room, direct telephone communications, and the like, a combination of such an information processing apparatus with the aforementioned information sharing means/method allows users at remote locations to communicate with each other through telephone communication, chat room or the like, while viewing the same moving image. For example, when a VTR tape which records a grandchild is sent to his/her grandfather and/or grandmother at a remote location, the parents can make a communication with the grandfather and/or grandmother through the telephone, chat room, or the like, while viewing the same recorded image together with them.

As to television broadcasting and radio broadcasting, since each program is delivered in accordance with a schedule determined by each broadcasting station, a plurality of users cannot always view the same program at the same time. Thus, the same information can be shared by a plurality of users if each of the users records programs on a recording medium such as a magnetic tape, an optical disc, or a magnetic disc. Also, when the user who recorded information on a recording medium sends the recording medium to a user who does not have the information, or delivers the information making use of a network such as the Internet, a plurality of users can share the same information. In this event, if the plurality of users sharing the same information can make communications with one another while reproducing the information in synchronization, the users can enjoy a form of communication that has not been so far provided to them.

However, with a conventional reproducing apparatus for reproducing information recorded on a recording medium, users at remote locations cannot reproduce information recorded on recording media possessed by the users in synchronization, so that they cannot simultaneously view the same information.

Therefore, assuming that some users are viewing, together with users at remote locations, contents such as a sports match, in which the development may largely change in a short time, if the respective users view different scenes at the same time, only some users know the result of the match prior to the others, possibly causing the other users to lose interest in the viewed contents or to discourage making conversations or chatting among the users.

### SUMMARY OF THE INVENTION

To solve the above inconvenience, the present invention provides an information reproducing method and system which are capable of displaying the same information on a plurality of terminal devices in synchronization at an arbitrary time.

To achieve the above object, a plurality of terminal devices for displaying information on screens are interconnected for making communications with one another through a network, wherein a terminal device which creates schedule data for displaying information on the screens of all the terminal devices at an arbitrary time delivers the schedule data to the other terminal devices through the network. Terminal devices which receive the schedule data reproduce the information associated with the schedule data from information previously recorded therein, thereby making it possible to display the same information on a plurality of screens in synchronization.

By doing so, users who utilize the respective terminal devices can make good communications with one another while viewing the same information. In other words, the users can be provided with a new form of communication.

In addition, a terminal device, which executes special reproduction during reproduction of the information, delivers manipulation data including a time at which special reproduction is executed during the reproduction of the information, the type of special reproduction, and a time elapsed from the start of the reproduction of the information to other terminals through the network. Then, each of the terminal devices which receives the manipulation data calculates a position at which the information is reproduced by the terminal device which transmitted the manipulation data, based on the manipulation data, and moves a scene to the reproduced position.

In this way, even when an arbitrary terminal device executes special reproduction during reproduction of information, scenes can be reproduced on the respective terminals in synchronization. It is therefore possible to more precisely match the reproduced scenes that are displayed on the respective terminal devices.

The above and other objects, features, and advantages of the present invention will become apparent from the following description with reference to the accompanying drawings that illustrate examples of the present invention.

### BRIEF DESCRIPTION OF THE DRAWINGS

FIG. 1 is a block diagram illustrating an exemplary configuration of an information reproducing system according to the present invention;

FIG. 2 is a block diagram illustrating an exemplary configuration of a schedule management server device shown in FIG. 1;

FIG. 3 is a block diagram illustrating an exemplary configuration of an information reproducing terminal device shown in FIG. 1;

FIG. 4 is a sequence diagram showing a procedure according to a first embodiment of an information reproducing method of the present invention; and

FIG. 5 is a sequence diagram showing a procedure according to a fifth embodiment of the information reproducing method of the present invention.

### DETAILED DESCRIPTION OF THE PREFERRED EMBODIMENTS

The information reproducing method and system according to the present invention provide features for interconnecting terminal devices possessed by respective users for reproducing information through a network such as the Internet to display in synchronization the same image on the respective terminal devices in accordance with schedule data indicative of recording and reproducing schedules for programs and the like, as well as manipulation data from a terminal device, on which the user has made special reproduction (fast forward, rewind, pause, restart), thereby permitting the users to make communications with one another, making use of audio and chatting functions.

While the following description will be made on an example in which television broadcasting programs are recorded and a recorded image is reproduced at an arbitrary time, recorded images are not limited to television broadcasting programs, but may include a recorded image, for example, captured by a video camera or the like.

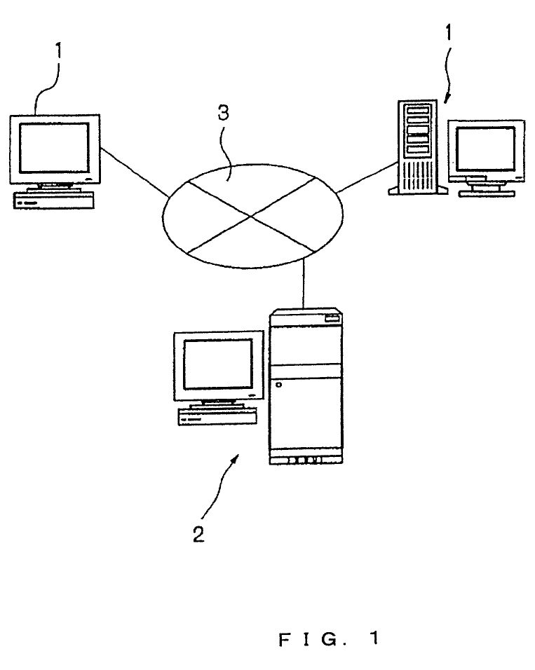

As illustrated in FIG. 1, the information reproducing system according to the present invention comprises information reproducing terminal devices 1 for use by respective users as information recording/reproducing means and as communication means; and schedule management server device 2 for managing a synchronous display of an image by information reproducing terminal devices 1, wherein information reproducing terminal devices 1 or each information reproducing terminal device 1 and schedule management server device 2 are interconnected to each other through network 3 such as the Internet to allow for communications therebetween. It should be understood that while FIG. 1 illustrates the configuration in which two information reproducing terminal devices 1 are connected to network 3, more information reproducing terminal devices 1 are actually connected to network 3.

Schedule management server device 2 may be an information processing apparatus such as a workstation, a server computer or the like which has a communication function for connecting to network 3, and is managed by a service provider which manages the information reproducing system of the present invention, or a third party which is entrusted with the operation by the service provider. Information reproducing terminal device 1, in turn, is an information processing apparatus such as a personal computer which has a communication function for connecting to network 3; a reception function for receiving television broadcasting, radio broadcasting and the like; and an information storage/reproduction function.

Alternatively, information reproducing terminal device 1 may be configured by a combination of an information processing apparatus such as a personal computer or a portable telephone with an information reproducing apparatus which has a reception function for receiving television broadcasting, radio broadcasting and the like, and an information storage/reproduction function.

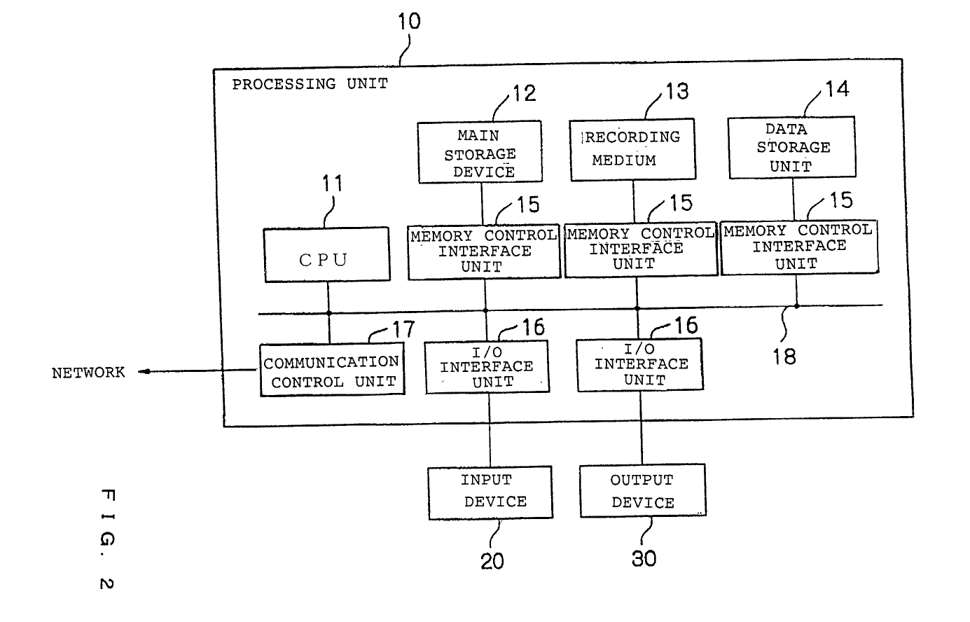

As illustrated in FIG. 2, schedule management server device 2 is composed of processing unit 10 for executing predetermined processing according to a program; input device 20 for inputting commands, information and the like to processing unit 10; and output device 30 for monitoring the result of processing performed by processing unit 10.

Processing unit 10 comprises CPU 11; main storage device 12 for temporarily storing data required for CPU 11 to execute processing; data storage unit 14 for storing schedule data for a plurality of information reproducing terminal devices 1 to record and reproduce the same program at the same time, program data which includes image data and audio data of a program to be viewed, data for authenticating respective users who are members of a community, and the like; recording medium 13 which has recorded thereon a control program for causing CPU 11 to execute registration/delivery processing and the like for the schedule data and program data; memory control interface unit 15 for controlling data transfers among main storage device 12, recording medium 13 and data storage unit 14; I/O interface unit 16 for interfacing with input device 20 and output device 30; and communication control unit 17 which is an interface for controlling communications through network 3. These components are interconnected through bus 18.

Processing unit 10 executes the registration/delivery processing and the like for the schedule data and program data, as described below, in accordance with the control program recorded on recording medium 13. Recording medium 13 may be a magnetic disk, a semiconductor memory, an optical disk, or any other recording medium.

As described above, schedule data transmitted from information reproducing terminal device 1, and program data for programs specified by the schedule data are registered and stored in data storage unit 14 of schedule management server device 2. Processing unit 10 generates a list of schedule data, which can be retrieved from information reproducing terminal device 1, based on the information stored in data storage unit 14, returns the list to information reproducing terminal device 1 which has requested the list, and also transmits the program data to information reproducing terminal device 1 if it requests transmission of the program data.

The schedule data specifies identification data for identifying a broadcasting station (for example, the name of the broadcasting station), broadcasting date, broadcasting start time, reproduction start time, and the like corresponding to each program. The schedule data list describes names of programs, reproduction start times, and the like, described, for example, in HTML (Hypertext Markup Language). In a “description” field associated with each program, a link is set so that information reproduction terminal device 1 can download schedule data corresponding to the program. For providing a plurality of user groups (hereinafter called the “community”) with similar services, schedule management server device 2 allocates a predetermined session ID for each community to determine information reproducing terminal devices 1 which belong to each community by the session ID.

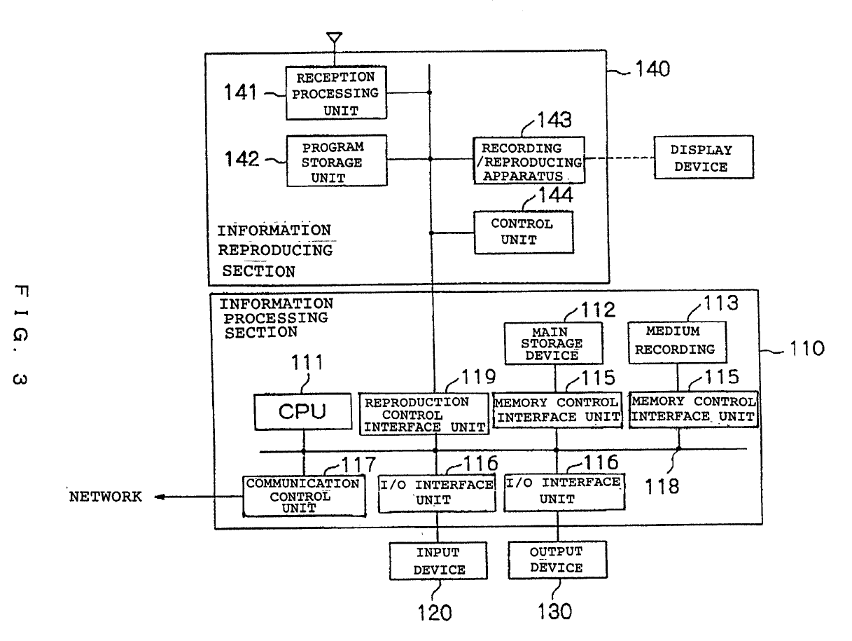

As illustrated in FIG. 3, information reproducing terminal device 1 is composed of information processing section 110 having a communication function for connecting to network 3; information reproducing section 140 having a program receiving function for receiving television broadcasting and radio broadcasting, and a storage/reproduction function for storing/reproducing program data and the like; input device 120 for inputting commands, data and the like to information processing section 110; and display device 130 for displaying the result of processing performed by information processing section 110 and images reproduced by information reproducing section 140.

Information processing section 110 is composed of CPU 111; main storage device 112 for temporarily storing data required for CPU 111 to execute processing; recording medium 113 which has recorded thereon programs for causing the CPU 111 to execute delivery/registration processing for schedule data and program data and program recording/reproducing processing, as well as processed data; memory control interface unit 115 for controlling data transfers among main storage device 112 and recording medium 113; I/O interface unit 116 for interfacing with input device 120, display device 130 and information reproducing section 140; reproduction control interface unit 119 for controlling data transfer with information reproduction unit 140; and communication control unit 117 which is an interface for controlling communications through network 3. These components are interconnected through bus 118.

Information processing section 110 executes schedule data generation processing, described below, according to the control program recorded on recording medium 113; recording/reproducing processing according to the schedule data; reception/delivery processing for schedule data and program; and the like. Recording medium 113 may be a magnetic disk, a semiconductor memory, an optical disk, or any other recording medium.

Information reproducing section 140 is composed of reception processing unit 141 for receiving television broadcasting, radio broadcasting and the like for conversion in accordance with a predetermined data recording scheme (for example, MPEG standard); program storage unit 142 for storing program data, schedule data and the like; recording/reproducing apparatus 143 for recording and reproducing information on and from program storage unit 142; and control unit 144 for controlling reception processing unit 141, program storage unit 142 and recording/reproducing apparatus 143, respectively, in accordance with instructions from information processing section 110 or instructions which are input through key manipulations. A display device may be directly connected to recording/reproducing apparatus 143.

Information reproducing terminal device 1 stores programs received by reception processing unit 141 of information reproduction unit 140, or program data acquired through network 3, and the like in program storage unit 142. In this event, the program data also includes data on a broadcasting station, broadcasting time and the like associated with the program.

Information reproducing terminal device 1 also generates schedule data for recording/reproducing a program selected by the user in information processing section 110 in response to key input manipulations of the user or making use of data such as a broadcasting station, broadcasting time and the like of the program, recorded together with the program data, and transmits the schedule data to other information reproducing terminal devices 1 or to schedule management server device 2 through network 3.

In addition, the program recording/reproducing operation may also be performed by the user who enters predetermined keys into information reproducing section 140 or information processing section 110 making use of EPG (Electronic Program Guide) or the like, as well as for recording/reproducing a specified program at a specified time in accordance with the schedule data. The EPG or the like is also used to include unattended-recording data for recording a program selected by the user into the schedule data.

Next, a procedure for implementing the information reproducing method according to the present invention will be described with reference to the drawings.

In the information reproducing method, a built-in clock in each information reproducing terminal device 1 must be precise in order to display the same information on a plurality of information reproducing terminal devices 1 at the same time in synchronization. For adjusting the built-in clock, the built-in clock may be set by time data acquired from an NTP (Network Time Protocol) server connected to network such as the Internet, or the built-in clock may be set by time data delivered on a particular channel of television broadcasting, as actually practiced in VTR apparatuses and the like, or the built-in clock may be set by time data delivered at VBI (Vertical Blanking Interval) of television broadcasting. The following description is made on the assumption that each of information reproducing terminal devices 1 connected to network 3 have precise built-in clocks.

### First Embodiment

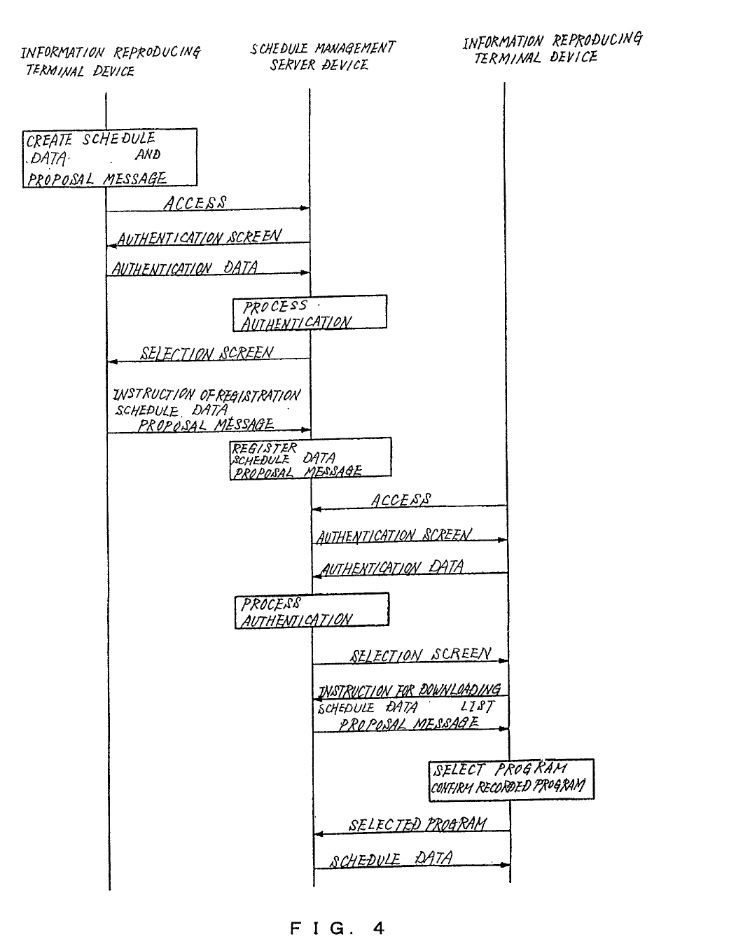

To begin with, a first embodiment of the information reproducing method according to the present invention will be described with reference to FIG. 4.

The information reproducing method according to the first embodiment is implemented in a situation where a plurality of users have recorded the same programs in information reproducing terminal devices 1, and an arbitrary user in a community specifies a program to be viewed by the plurality of user to generate schedule data which is delivered to the remaining users such that the reproduction of the same image is started at a specified time by information reproducing terminal device 1 of each user based on the schedule data.

As shown in FIG. 4, an arbitrary user first selects a desired program to be viewed by the plurality of users from programs recorded in program storage unit 142, and enters a reproduction time for the program in information reproducing terminal device 1 which responsively generates schedule data for reproducing the selected program at the time specified by the user.

Subsequently, the user who created the schedule data creates a proposal message for proposing the other users in the.community to view the recorded program, and enters an instruction into information reproducing terminal device 1 for registering the schedule data. In response, information reproducing terminal device 1 accesses schedule management server device 2 through network 3.

Schedule management server device 2 returns data on an authentication screen to information reproducing terminal device 1 for prompting the user to enter his ID, password and the like to confirm that accessing information reproducing terminal device 1 is owned by a user who has been registered as a member in the community.

As the user enters authentication data such as the ID, password and the like into information reproducing terminal device 1 pursuant to instructions on the authentication screen, information reproducing terminal device 1 transmits the entered authentication data to schedule management server device 2.

Schedule management server device 2 confirms, using the received authentication data, whether or not accessing information reproducing terminal device 1 is owned by a user who has registered as a member, and transmits data on a selection screen for prompting the user to select registration/downloading of schedule data upon confirming that accessing information reproducing terminal device 1 is owned by a user who has registered as a member.

As the user enters a selection for registration of schedule data pursuant to instructions on the selection screen, information reproducing terminal device 1 transmits a schedule data registration instructing message, a proposal message for proposing the other users in the community to view the recorded program, and the created schedule data, respectively.

Schedule management server device 2 stores the received proposal message and schedule data in data storage unit 14 for registration therein.

On the other hand, if another user in the community accesses schedule management server device 2 using information reproducing terminal device 1, schedule management server device 2 first confirms in a similar procedure to the foregoing whether or not accessing information reproducing terminal device 1 is owned by a user who has registered as a member.

Upon confirming that accessing information reproducing terminal device 1 is owned by a user who has registered as a member, schedule management server device 2 transmits data on a selection screen for prompting the user to select registration/downloading of the schedule data.

As the user selects downloading of the schedule data pursuant to instructions on the selection screen, information reproducing terminal device 1 transmits a request for downloading the schedule data to schedule management server device 2.

Upon receipt of the request for downloading the schedule data from information reproducing device 1, schedule management server device 2 confirms a session ID of this information reproducing terminal device 1, creates a list of schedule data that can be delivered within the same community, and returns to information reproducing terminal device 1 data on the list, and the proposal messages each for proposing the other users to view a registered recorded program associated therewith.

As the user selects schedule data associated with a program which the user agrees to view with reference to the schedule data list and proposal messages, information reproducing terminal device 1 confirms whether or not the program specified by the schedule data has been recorded in program storage unit 142, and when it has not been recorded, displays a message, indicating that the program has not been recorded, on display device 130, and terminates the procedure.

When the selected program has been recorded in program storage unit 142, information reproducing terminal device 1 transmits a message, indicating that the program has been selected, to schedule management server device 2.

Schedule management server device 2 retrieves schedule data corresponding to the program selected by the user, transmitted from information reproducing terminal device 1, from data storage unit 14, and transmits the retrieved schedule data to information reproducing terminal device 1.

Information reproducing terminal device 1 records the received schedule data in program storage unit 142, retrieves specified program data stored in program storage unit 142 at a specified time pursuant to the schedule data, and reproduces the recorded image on the display device through recording/reproducing apparatus 143.

While in the foregoing description, the built-in clocks in information reproducing terminal devices 1 owned by the respective users in the community are all set at the same time, it is possible to view the same information at the same time in regions which have a time difference therebetween, provided that information reproducing terminal device 1 has a function of converting the time of schedule data.

For example, information reproducing terminal device I1 which creates schedule data may indicate a reproduction start time within the schedule data in Greenwich Mean Time. Alternatively, time zone data may be included in the schedule data for showing a standard time of which region is used to indicate a reproduction start time. In this case, information reproducing terminal device 1, which receives the schedule data, converts the information reproduction start time within the schedule data to a standard time in its own region and utilizes the converted information reproduction start time.

Also, while the foregoing description has been made on an example in which schedule data and associated proposal messages are delivered from schedule management server device 2 to information reproducing terminal device 1, the schedule data and proposal message may be directly delivered from information reproducing terminal device 1 owned by the user who created the schedule data to information reproducing terminal device 1 owned by each of users in the community. In this case, the user who created the schedule data transmits a proposal message for proposing respective users in the community to view the recorded program, such that information reproducing terminal devices 1 of users who agree with the proposal, out of the users who have received the proposal message, download the schedule data from information reproducing terminal device 1 of the user who transmitted the proposal message.

According to the information reproducing method of the first embodiment described above, since a plurality of information reproducing terminal devices 1 simultaneously start reproducing the same program in accordance with schedule data, users who utilize respective information reproducing terminal devices 1 can make good communications with one another while viewing the same program.

### Second Embodiment

Next, description will be made of a second embodiment of the information reproducing method according to the present invention.

In the information reproducing method according to the second embodiment, a user who created schedule data registers the schedule data and associated program data, respectively, and if a user in a community has not recorded a specified program in information reproducing terminal device 1, the user receives the program data together with the schedule data. Then, information reproducing terminal devices 1 of respective users start reproducing the same image at a specified time based on the schedule data and program data.

The second embodiment employs a procedure similar to that in the first embodiment, wherein an arbitrary user creates schedule data and proposal message using information reproducing terminal device 1, and registers information on a program to be reproduced in accordance with the schedule data, together with the created proposal message and schedule data, in schedule management server device 2.

In such a state, as another user in the community accesses schedule management server device 2 using information reproducing terminal device 1, schedule management server 2 authenticates the user in a procedure similar to that in the first embodiment, prompts the accessing user to select downloading of schedule data, and returns a schedule data list and proposal messages to information reproducing terminal device 1.

As the user selects schedule data associated with a program which the user agrees to view with reference to the schedule data list and proposal messages, information reproducing terminal device 1 determines whether or not the selected program has been recorded in program storage unit 142, and displays the result of determination.

In the second embodiment, if the selected program has not been recorded in program storage unit 142, information reproducing terminal device 1 transmits a request for transmitting associated program data together with the program selection message to schedule management server device 2.

Schedule management server device 2 retrieves the schedule data associated with the program selected by the user, and program data from data storage unit 14, and transmits the respective data to information reproducing terminal device 1.

The information reproducing terminal device 1 stores the received schedule data and program data in program storage unit 142, and retrieves the program data stored in program storage unit 142 at a specified time, and reproduces the recorded image on display device 130 through recording/reproducing apparatus 143 pursuant to the schedule data.

While the foregoing description has been made on an example in which schedule data and program data are delivered from schedule management server device 2 to information reproducing terminal device 1, the schedule data and program data may be directly delivered from information reproducing terminal device 1 owned by the user who created the schedule data to information reproducing terminal device 1 owned by each of users in the community. In this case, the user who created the schedule data transmits a proposal message for proposing respective users in the community to view the program, such that information reproducing terminal devices 1 of users who agree with the proposal, out of the users who have received the proposal message, download the schedule data from information reproducing terminal device 1 of the user who transmitted the proposal message.

When not only schedule data but also program data are delivered from information reproducing terminal device of a user who proposes to view a program, those users who have not recorded the program can also participate in conversations and chatting in the community while viewing the same program.

### Third Embodiment

Next, description will be made of a third embodiment of the information reproducing method according to the present invention.

The information reproducing method according to the third embodiment is implemented when users in a community have not recorded program data in their information reproducing terminal devices 1, wherein an arbitrary user specifies a program to be viewed by a plurality of users to create schedule data for unattended recording and reproduction, delivers the schedule data to other users, such that the same program is recorded in information reproducing terminal device of each user and reproduced at the same time.

In the third embodiment, an arbitrary user selects a desired program to be viewed by a plurality of users from a program table such as EPG, and enters a reproduction time for the program into information reproducing terminal device 1. In response, information reproducing terminal device 1 creates schedule data for reproducing the selected program at the specified time. In this event, the schedule data includes unattended-recording data for recording the selected program.

The schedule data including this unattended-recording data is registered in schedule management server device 2 in a procedure similar to that in the first embodiment.

Other users in the community receive the schedule data from schedule management server device 2 and records the received schedule data in program storage unit 142 in a similar procedure to that in the first embodiment.

In the third embodiment, since the schedule data includes the unattended-recording data for the specified program data reproducing terminal device 1 which has recorded the schedule data sets for unattended recording of the specified program, and starts reproducing the program at the specified time pursuant to the schedule data.

In the third embodiment, as is the case with the first embodiment, the schedule data and proposal message may be directly delivered from information reproducing terminal device 1 owned by the user who created the schedule data to information reproducing terminal device 1 owned by each of users in the community. In this case, the user who created the schedule data transmits a proposal message for proposing respective users in the community to view the recorded program, such that information reproducing terminal devices 1 of users who agree with the proposal, out of the users who have received the proposal message, download the schedule data from information reproducing terminal device 1 of the user who transmitted the proposal message.

When the unattended-recording data is included in the schedule data like the third embodiment, a program to be broadcast in the future is recorded without fail by information reproducing terminal device 1 of each of users who agree to view the program, the respective users in the community can make good communications with one another while viewing the same program, similar to the first embodiment.

### Fourth Embodiment

Next, description will be made of a fourth embodiment of the information reproducing method according to the present invention.

The information reproducing method according to the fourth embodiment is implemented when a plurality of users have recorded the same program in their information reproducing terminal devices, wherein an arbitrary user in a community specifies a program to be viewed-by a plurality of users, creates schedule data including scenario data which records a log of special reproducing operations (fast forward, rewind, pause, restart), and delivers the schedule data to the other users, such that the same image is reproduced in the information reproducing terminal device of each user at the same time based on the schedule data.

The scenario data is comprised of a plurality of entries, each of which records a time elapsed from the start of program reproduction, and the type of manipulation made by the user (fast forward, rewind, pause, restart).

In the fourth embodiment, an arbitrary user selects a desired program to be viewed by a plurality of users from programs recorded in the program storage unit, instructs creation of scenario data, and views the program while performing special reproduction. In this event, a record of special reproduction performed by the user is registered as scenario data, such that information reproducing terminal device 1 generates schedule data for reproducing the selected program at a specified time in accordance with the scenario data.

Subsequently, in a procedure similar to that in the first embodiment, the schedule data is. registered in schedule data management server 1, and other users in the community download the schedule data into their own information reproducing terminal devices 1.

Each information reproducing terminal device 1 in the community reproduces the specified program as instructed by the scenario data at the specified time in accordance with the schedule data that includes the scenario data.

In the fourth embodiment, as is the case with the first embodiment, the schedule data and proposal message may be directly delivered from information reproducing terminal device 1 owned by the user who created the schedule data to information reproducing terminal device 1 owned by each of users in the community. In this case, the user who created the schedule data transmits a proposal message for proposing respective users in the community to view the recorded program, such that information reproducing terminal devices 1 of users who agree with the proposal, out of the users who have received the proposal message, download the schedule data from information reproducing terminal device 1 of the user who transmitted the proposal message.

When the scenario data is included in the schedule data as the fourth embodiment, information reproducing terminal device 1 of each user reproduces the same program in accordance with a log of special reproduction manipulated by an arbitrary user, so that this embodiment can produce similar effects to those of the first embodiment.

### Fifth Embodiment

Next, a fifth embodiment of the information reproducing method according to the present invention will be described with reference to the drawings.

The information reproducing method according to the fifth embodiment, similar to the first embodiment, is implemented in a situation where each of the users in a community has recorded the same program in information reproducing terminal device 1, and an arbitrary user generates schedule data for specifying a program to be viewed by a plurality of users and delivers the schedule data to the other users, such that the same image is reproduced by information reproducing terminal device 1 of each user at the same time based on the delivered schedule data. In addition, the information reproducing method of this embodiment is adapted to support special reproduction (fast forward, rewind, pause, restart) performed by an arbitrary user through manipulations on information reproducing terminal device 1 during reproduction of a program, such that images displayed on information reproducing terminal devices 1 of the other users are synchronized to the special reproduction.

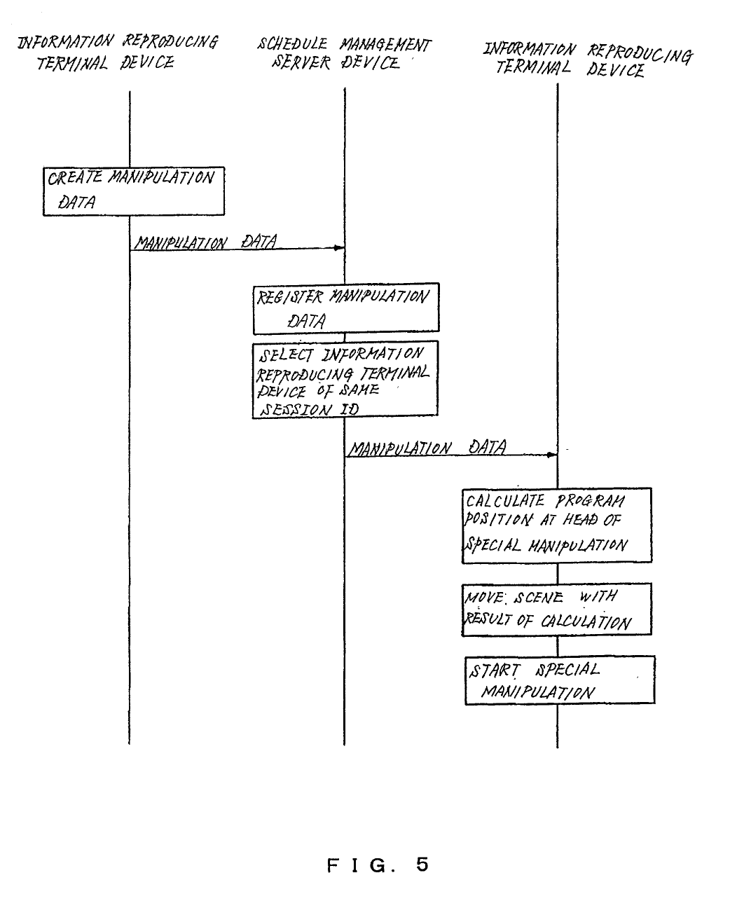

Since a procedure for registering and downloading schedule data in the fifth embodiment is similar to that of the first embodiment, description thereon is omitted. The following description will be focused on the synchronization processing for synchronizing images displayed on information reproducing terminal devices 1 of respective users to special reproduction manipulated by an arbitrary user with reference to FIG. 5.

As illustrated in FIG. 5, when an arbitrary user performs a manipulation for special reproduction during reproduction of a program, associated information reproducing terminal device 1 creates data on the manipulation, and transmits the data to schedule management server device 2. The manipulation data is composed of the time at which the manipulation was performed, the type of manipulation, and a position of the program reproduced when the manipulation was performed (time elapsed from the beginning of the program).

Schedule management server device 2 registers the received manipulation data in data storage unit 14, selects other information reproducing terminal devices 1 which have been assigned the same session ID as information reproducing terminal device 1 which transmitted the manipulation data, and transmits the manipulation data to respective selected information reproducing terminal devices 1.

Each of information reproducing terminal devices 1 which receives the manipulation data calculates a position of a program (reproduced scene) at which the special manipulation is started from the difference between the time at which the manipulation was performed and the current time, the type of manipulation, and a position reproduced at the time the manipulation was performed, included in the manipulation data.

Next, information reproducing terminal device 1 moves the scene displayed thereon in accordance with the result of calculation, and starts the same special manipulation as information reproducing device 1 which transmitted the manipulation data, from the moved scene.

For example, assuming that the manipulation time is 9:00:00, the time at which the manipulation data arrived is 9:00:02, the type of manipulation is double-speed fast forward, and the scene displayed when the manipulation data was received is at X1 seconds from the beginning of the program data reproducing terminal device 1 which has received the manipulation data starts double-speed fast forward from a scene at X1-2 seconds from the beginning of the program.

Also, assuming that the manipulation time is 9:00:20, the time at which the manipulation data arrived is 9:00:22, the type of manipulation is normal reproduction after double-speed fast forward, and the scene displayed when the manipulation data was received is at X2 seconds from the beginning of the program data reproducing terminal device 1 which has received the manipulation data starts normal reproduction from a scene at X2-2 seconds from the beginning of the program.

The method for calculating the position of the program (reproduced scene) at which special manipulation is started is not limited to that described above, but any method may be employed as long as it can establish the synchronization for the special manipulation.

For example, when the manipulation time is T1, the time at which the manipulation data arrived is T2, the type of manipulation is n-times fast reproduction (n<0 for rewind, and n=0 for pause), and the scene displayed at the time the special manipulation was started is at Y1 seconds from the beginning of the program data reproducing terminal device 1 which receives the manipulation data calculates a position Y2 at which the special manipulation is started according to the following equation:

Y2=Y1+(T2−T1)×n

Specifically, assuming that the manipulation time is 9:00:00, the time at which the manipulation data arrived is 9:00:02, the type of manipulation is double-speed fast forward, and a scene of the program at the time the special manipulation was started is at X3 seconds from the beginning of the program data reproducing terminal device 1 which receives the manipulation data starts double-speed fast forward from a scene at X3+4 seconds from the beginning of the program.

Also, assuming that the manipulation time is 9:00:20, the time at which the manipulation data arrived is 9:00:22, the type of manipulation is normal reproduction after double-speed fast forward (n=−2), and a scene of the program at the time the special manipulation started is X4 seconds from the beginning of the program data reproducing terminal device 1 which receives the manipulation data starts normal reproduction from a scene at X4-4 seconds from the beginning of the program.

As each information reproducing terminal device 1 individually executes such processing, even if a special reproduction is executed by an arbitrary information reproducing terminal device 1 during reproduction of information, a scene reproduced on each information reproducing terminal device 1 can be synchronized to the special reproduction, thereby making it possible to more precisely match the scenes reproduced on respective information reproducing terminal devices 1.

While the foregoing description has been made on an example in which the manipulation data is delivered from schedule management server device 2 to information reproducing terminal devices 1, the manipulation data may be directly delivered from information reproducing terminal device 1 which transmitted the manipulation data to information reproducing terminal devices 1 owned by respective users in the community.

In this case, a particular one of a plurality of information reproducing terminal devices 1 may be allowed to perform special manipulations, or information reproducing terminal devices 1 may be prioritized such that when special manipulations are performed simultaneously, manipulation data is transmitted from information reproducing terminal device 1 having the highest priority level to other information reproducing terminal devices 1. In this way, even when different special manipulations are performed simultaneously on a plurality of information reproducing terminal devices 1, the same image can be reproduced on respective information reproducing terminal devices 1 in synchronization without confusion.

While preferred embodiments of the present invention have been described using specific terms, such description is for illustrative purposes only, and it is to be understood that changes and variations may be made without departing from the spirit or scope of the following claims.

What is claimed is:

1. An information reproducing method for displaying the same information on a plurality of screens in synchronization with one another, said method comprising the steps of:
connecting a plurality of terminal devices each for displaying said information on a screen for making communications through a network;
delivering schedule data for reproducing said information on said screens at an arbitrary time from a terminal device which created said schedule data to other terminal devices through said network; and
instructing a terminal device which receives said schedule data to reproduce said information from among previously recorded information in accordance with said schedule data.

2. The information reproducing method according to claim 1, further comprising the step of:
instructing said terminal device to receive said information delivered from said terminal device which created said schedule data through said network, when information to be reproduced in accordance with said schedule data has not been recorded in a terminal device which receives said schedule data.

3. The information reproducing method according to claim 1, wherein:
said schedule data includes unattendedrecording data for recording predetermined information delivered at predetermined date and time.

4. The information reproducing method according to claim 1, wherein:
said schedule data includes scenario data which records a manipulation procedure for special reproduction executed during reproduction of said information together with the lapse of time from the start of reproduction.

5. The information reproducing method according to claim 1, further comprising the steps of:
delivering manipulation data to other terminal devices through said network, from a terminal device which executes special reproduction during reproduction of said information, said manipulation data including a time at which the special reproduction is executed, the type of the special reproduction, and a time elapsed from the start of reproduction of said information; and
instructing a terminal device which receives said manipulation data to calculate a position at which the special reproduction is started on said information based on said manipulation data, move a scene to said start position, and perform the same type of special reproduction as that performed by said terminal device which transmits said manipulation data from said start position to which the scene is moved.

6. An information reproducing system for displaying the same information on a plurality of screens in synchronization with one other, said system comprising:
an information reproducing terminal device for recording information delivered at predetermined date and time, and reproducing said information in accordance with schedule data received through a network, said schedule data instructing said information reproducing terminal device to reproduce said information on said screen at an arbitrary time, wherein said information terminal device delivers said schedule data through the network when said information terminal device itself creates said schedule data; and
a schedule management server device storing said schedule data transmitted from said information reproducing terminal device, and returning said schedule data through the network to said information reproducing terminal device which requests transmission of said schedule data.

7. The information reproducing system according to claim 6, wherein:
said information reproducing terminal device receives information to be reproduced in accordance with said schedule data through the network when said information has not been recorded therein, and delivers information corresponding to said schedule data when said information reproducing terminal device creates said schedule data, and
said schedule management server device stores said information to be reproduced in accordance with said schedule data, said information transmitted from said information reproducing terminal device, and returns said information to said information reproducing terminal device which requests transmission of said information.

8. The information reproducing system according to claim 6, wherein:
said schedule data includes unattended-recording data for recording predetermined information which is delivered at predetermined date and time.

9. The information reproducing system according to claim 6, wherein:
said schedule data includes scenario data which records a manipulation procedure for special reproduction executed during reproduction of said information together with the lapse of time from the start of reproduction.

10. The information reproducing system according to claim 6, wherein:
said information reproducing terminal device delivers manipulation data including a time at which special reproduction is executed during reproduction of said information, the type of the special reproduction, and a time elapsed from the start of reproduction of said information through the network;
said information reproducing terminal device, upon receipt of said manipulation data through the network, calculates a position at which the special reproduction is started on said information based on said manipulation data, moves a reproduced scene to said start position, and performs the same type of special reproduction as that performed by said terminal device which transmits said manipulation data from said start position to which the scene is moved, and
said schedule management server device, upon receipt of said manipulation data from said information reproducing terminal device, transmits said manipulation data to each of information reproducing terminal devices owned by a group of users to which said information reproducing terminal device belongs.

11. A server device for conducting management for displaying the same information on a plurality of screens in synchronization with one another, comprising:
a data storage unit for storing schedule data for reproducing said information on said screen at an arbitrary time, said information being transmitted from a terminal device for displaying said information on a screen through a network; and
a processing unit for returning said schedule data to a terminal device which requests transmission of said schedule data through the network.

12. The server device according to claim 11, wherein:
said data storage device stores information to be reproduced in accordance with said schedule data, said information being transmitted from said terminal device, and
said processing unit returns said information to a terminal device which requests transmission of said information.

13. The server device according to claim 11, wherein:
said schedule data includes unattended-recording data for recording predetermined information delivered at predetermined date and time.

14. The server device according to claim 11, wherein:
said schedule data includes scenario data which records a manipulation procedure for special reproduction executed during reproduction of said information together with the lapse of time from the start of reproduction.

15. The server device according to claim 11, wherein:
said processing unit, upon receipt of manipulation data including a time at which special reproduction is executed during reproduction of said information, the type of the special reproduction, and a time elapsed from the start of reproduction of said information from said terminal device, transmits said manipulation data to respective terminal devices owned by a group of users to which said terminal device belongs.

16. A terminal device for displaying the same information on a screen in synchronization with a plurality of other terminal devices, comprising:
an information reproducing section for recording information delivered at predetermined date and time, and schedule data received through a network for reproducing said information on said screen at an arbitrary time; and
an information processing section for reproducing said information in accordance with said schedule data, and delivering said schedule data through the network when said information processing section itself creates said schedule data.

17. The terminal device according to claim 16, wherein:
said information processing section receives information to be reproduced in accordance with said schedule data if said information has not been recorded therein, and delivers information corresponding to said schedule data when said information processing section itself creates said schedule data, and
said information reproducing section records the information to be reproduced in accordance with said schedule data, said information being received by said information processing section.

18. The terminal device according to claim 16, wherein:
said schedule data includes unattended-recording data for recording predetermined information delivered at predetermined date and time.

19. The terminal device according to claim 16, wherein:
said schedule data includes scenario data which records a manipulation procedure for special reproduction executed during reproduction of said information together with the lapse of time from the start of reproduction.

20. The terminal device according to claim 16, wherein:
said information processing section delivers manipulation data including a time at which special reproduction is executed during reproduction of said information, the type of the special reproduction, and a time elapsed from the start of reproduction of said information through the network, and upon receipt of said manipulation data through the network, calculates a position at which the special reproduction is started for said information based on said manipulation data, moves a reproduced scene to said start position, and performs the same type of special reproduction as that performed by said terminal device which transmits said manipulation data from said start position to which the scene is moved.

21. A program for causing a computer to execute processing for displaying the same information on a plurality of screens in synchronization, said program causing the computer to perform the steps of:
storing in a storage device schedule data for reproducing said information on said screen at an arbitrary time, said information being transmitted from a terminal device for displaying said information on a screen through a network; and
returning said schedule data to a terminal device which requests transmission of said schedule data through the network.

22. The program according to claim 21, further causing the computer to perform the steps of:
storing information to be reproduced in accordance with said schedule data, said information being transmitted from said terminal device; and
returning said information to a terminal device which requests transmission of said information.

23. The program according to claim 21, wherein:
said schedule data includes unattended-recording data for recording predetermined information delivered at predetermined date and time.

24. The program according to claim 21, wherein:
said schedule data includes scenario data which records a manipulation procedure for special reproduction executed during reproduction of said information together with the lapse of time from the start of reproduction.

25. The program according to claim 21, further causing the computer to perform the step of:
transmitting manipulation data to respective terminal devices owned by a group of users to which said terminal device belongs, upon receipt of said manipulation data including a time at which special reproduction is executed during reproduction of said information, the type of the special reproduction, and a time elapsed from the start of reproduction of said information from said terminal device.

26. A program for causing a computer to execute processing for displaying the same information on a plurality of screens in synchronization, said program causing the computer to perform the steps of:
recording in a storage device information delivered at predetermined date and time, and schedule data received through a network for reproducing said information on said screen at an arbitrary time; and
reproducing said information in accordance with said schedule data, and delivering said schedule data through a network when creating said schedule data.

27. The program according to claim 26, further causing the computer to perform the steps of:
receiving information to be reproduced in accordance with said schedule data if said information has not been recorded therein;
storing said information in a storage device; and
delivering information corresponding to said schedule data when creating said schedule data.

28. The program according to claim 26, wherein:
said schedule data includes unattendedrecording data for recording predetermined information delivered at predetermined date and time.

29. The program according to claim 26, wherein:
said schedule data includes scenario data which records a manipulation procedure for special reproduction executed during reproduction of said information together with the lapse of time from the start of reproduction.

30. The program according to claim 26, further causing the computer to perform the steps of:
delivering manipulation data through the network, said manipulation data including a time at which special reproduction is executed during reproduction of said information, the type of the special reproduction, and a time elapsed from the start of reproduction of said information; and
upon receipt of said manipulation data through the network, calculating a position at which the special reproduction is started for said information based on said manipulation data, moving a reproduced scene to said start position, and performing the same type of special reproduction as that performed by said terminal device which transmits said manipulation data from said start position to which the scene is moved.
